(19) United States
(12) Patent Application Publication
(10) Pub. No.: US 2004/0238590 A1
(43) Pub. Date: Dec. 2, 2004

(54) On-off valve

(75) Inventors: Yoshinori Ishizawa, Ibaraki (JP); Masao Hamada, Ibaraki (JP); Akira Oono, Ibaraki (JP)

Correspondence Address: MCGINN & GIBB, PLLC, 8321 OLD COURTHOUSE ROAD, SUITE 200, VIENNA, VA, 22182-3817, US

(73) Assignee: Hitachi Koki Co., Ltd., Tokyo (JP)

(21) Appl. No.: 10/849,936

(22) Filed: May 21, 2004

(30) Foreign Application Priority Data
May 26, 2003 (JP) P.2003-148442

(51) Int. Cl. B25C 1/04

(52) U.S. Cl. 227/130; 227/8

(57) ABSTRACT

An on-off valve has a cylindrical bush through which a fluid is passed, a hole communicating an interior of the cylindrical bush with an atmosphere, an on/off operator which slides along an outer periphery of the cylindrical bush in an axial direction to open and close the hole and a stopper elastic body which is served to position the on/off operator.

### BACKGROUND OF THE INVENTION

1. Field of the Invention

The present invention relates to an on-off valve for fluid such as compressed air, water, oil, etc.

2. Description of the Related Art

Previously known positioning systems of the on-off valve for compressed air, water, etc. are disclosed in JP-A-9-131669 and JP-A-10-138165.

In the positioning system disclosed in JP-A-9-131669, as seen from FIGS. 6 and 7, a bush 50 in which an on-off operator 29 slides has a positioning groove 37 for positioning the on-off operator 29. The on-off operator 29 includes a first elastic body 51 and a second elastic body 52. The on-off operator 29 which is cylindrical slides in a hole 53 made within the bush 50 so as to have the same shape as the bush 50.

In FIG. 6, at the position where the on-off operator 29 communicates an air path 54 and an air path 55 with each other, the second elastic body 52 engages with the positioning groove 37 to position the on-off operator 29 whereas the first elastic body 51 interrupts the air paths 54 and 55 from the atmosphere.

In FIG. 7, at the position where the on-off operator 29 cuts off the air paths 54 and 55, the first elastic body 51 engages with the positioning groove 37 to position the on-off operator 29 whereas the second elastic body 52 interrupts the air path 55 from the atmosphere.

In the positioning system disclosed in JP-A-10-138165, as seen from FIGS. 8 and 9, the on-off operator 29 has grooves 56 and 57 for positioning itself. The bush 50 has a steel ball 54 and a spring 55. Like the case of FIGS. 6 and 7, the on-off operator 29 which is cylindrical slides in a hole 53 within the bush 50 so as to have the same shape as the bush 50.

In FIG. 8, at the communicating position where the on-off operator 29 communicates a nailer body 2 with an air hose, the groove 57 engages with the steel ball 54 to position the on/off operator 29, whereas an O-ring 58 moves to communicate the nailer body 2 and the air hose with each other.

In FIG. 9, at the cut-off position where the on-off operator 29 interrupts the nailer body 2 from the air hose, the groove 56 engages with the steel ball 54 to position the operator 29, whereas the O-ring 58 cuts off the nailer body 2 from the air hose.

In a prior art as shown in FIGS. 10 and 11, a bush 50 along the outer periphery of which an on-off operator 29 slides is, on the outer periphery, provided with a positioning groove 37 for positioning the on-off operator 29. The on-off operator 29 has O-rings 34 and 35. At the lower part of FIGS. 10 and 11, a stopper elastic body 31 for preventing the on-off operator 29 from coming off is fit in a groove 32 of the bush 50. The bush 50 is formed in a cylindrical shape to form an air path and has an air path 33 made in a normal direction for communication with the atmosphere. The on-off operator 29 is formed in a cylindrical shape so that it slides along the outer periphery of the bush 50 in an axial direction.

At the interrupting position where the on-off operator 29 interrupts the air path 33, the O-ring 35 engages with the positioning groove 37 to serve to position the on-off operator 29 and interrupt the air path from the atmosphere, whereas the O-ring 34 interrupts the air path from the atmosphere. At the communicating position where the on-off operator 29 communicates the air path 33 with the atmosphere, the O-ring 34 engages with the positioning groove 37 to position the on-off operator 29, whereas the O-ring 35 moves downward along the outer periphery of the bush 50 while being deformed with an interference.

### SUMMARY OF THE INVENTION

In the positioning mechanism of the on-off valve in a system in which the on-off operator slide along the outer periphery of the bush as shown in FIGS. 10 and 11, at the interrupting position, the O-ring serves to engage with the positioning groove and also interrupt the air path from the atmosphere. Therefore, the O-ring must be sealed in the positioning groove having a smaller outer diameter than that of the sliding face of the bush. However, immediately after the on-off operator has been moved from the communicating position to the interrupting position, as the case may be, the O-ring remains deformed in the shape following the sliding face of the bush and hence does not follow the shape of the positioning groove so that it is not sealed in the positioning groove. Particularly, at a low temperature, the O-ring is hardened to be further difficult to follow the shape of the groove, thus making phenomenon remarkable. In order that the O-ring follows the shape of the groove, the O-ring was given a great interference. However, in this case also, the O-ring remains followed the sliding face of the bush.

In the positioning system disclosed in JP-A-9-131699, as shown in FIG. 6 and FIG. 7, since the groove is located on the outer periphery of the O-ring, even when the elastic body is deformed to follow the shape of the groove toward the outer periphery, the elastic body is deformed slightly inward when sealed and so poor sealing is not produced.

In the positioning system disclosed in JP-A-10-138165, as shown in FIG. 8 and FIG. 9, the positioning mechanism is provided separately from the O-ring, the poor sealing due to remaining to follow the groove is not produced. Further, in the configuration shown in FIGS. 10 and 11, providing the positioning mechanism by the engagement of the groove with a steel ball increases the number of components, production cost and time for assembling and also increases the size of the positioning system. This leads to difficulty in assembling.

In order to solve the inconvenience, according to a first aspect of the invention, an object of the present invention is to provide a positioning system in which an O-ring is prevented from remaining deformed, thereby surely following a groove shape to be sealed. The above object is realized by the structure in which the O-ring is employed for sealing and the stopper elastic body is served to position the on/off operator.

According to a second aspect of the invention, the invention provides the structure in which the stopper elastic body is fit over the outer periphery of the cylindrical bush; and the on-off operator has an positioning groove providing an outer diameter not smaller than the stopper elastic body does, a sliding face sliding in the axial direction with the stopper elastic body and a wall permitting the on/off operator to slide over only a prescribed distance; a diameter of the positioning groove is more than that of the sliding face and a diameter of the wall is smaller than that of the sliding face.

According to a third aspect of the invention, an object of the invention is to prevent the on-off operator from coming off from the groove in which the elastic body stopper is fit when the on-off operator is operated in an axial direction. The above object is realized by the structure in which a groove having a substantially circular shape is formed on the outer periphery of the cylindrical bush, the stopper elastic body is disposed in the groove formed on the outer periphery of the cylindrical bush, an extended line of line coupling a central position of a cross-section of the stopper elastic body with an intersecting point of the groove and an inner periphery of the wall passes nearer to an axial center than an intersection of a side wall of the groove and the inner periphery of the wall.

According to a fourth aspect of the invention, an object of the present invention is to reduce the number of grooves for positioning in order to simplify the structure, thereby reducing the cost, size and weight. The above object is realized by the structure in which the on/off operator is positioned at an intersecting point of the sliding inner diameter between the on/off operator and said stopper elastic body fit over the cylindrical bush and an end face of the on/of operator.

According to a fifth aspect of the invention, an object of the present invention is to seal the O-ring surely in a system in which the O-ring serves to position the on-off operator and interrupt the air path from the atmosphere. The above object is realized by the structure in which the sealing member served for sealing and positioning by engagement with the positioning groove at an interrupting position of the on/off operator gives a smaller interference at a communicating position of the on/off operator than at the interrupting position so that the sealing member is surely deformed during sealing.

According to a sixth aspect of the invention, an object of the invention is to prevent the seal members from remaining deformed. The above object is realized by An on-off valve including a substantially cylindrical bush having an air path, which communicates an outside of the bush with an inside of the bush; an on/off operator inserted at an outer periphery of the bush, having a substantially circular shape, and including a first groove having a substantially circular shape and formed on an inner periphery of the bush; and a second groove having a substantially circular shape and being apart from the first groove; a first elastic body disposed in the first groove, having a substantially annular shape, and being slidable along the outer periphery of the bush; a second elastic body disposed in the second groove, having a substantially annular shape, and being slidable along the outer periphery of the bush; and a third elastic body disposed in a third groove, which has a substantially circular shape and is formed on the outer periphery of the bush, and protruding from the outer periphery of the bush, in which the on/off operator switches between a cut-off position where the air path is located between the first elastic body and the second elastic body so as to insulate an atmosphere from the air path and a communication position where the air path is not located between the first elastic body and the second elastic body so as to communicate the air path with the atmosphere; and a positioning groove has a substantially circular shape, is formed on an inner periphery of the bush, and is opposed to the third elastic body when the on/off operator is at the cut-off position or the communicative position.

According to a seventh aspect of the invention, an object of the invention is to offer a retaining effect to positioning members. The above object is realized by an on-off valve, in which when the on/off operator moves between the cut-off position and the communicative position, an inner diameter of the on/off operator is smaller than that of the positioning groove on one side facing the third elastic body as viewed from the positioning groove, and when the on/off operator moves between the cut-off position and the communicative position, the inner diameter of the on/off operator is larger than an outer diameter of the bush at the other side as viewed from the positioning groove.

According to an eight aspect of the invention, an object of the invention is to be able to position without changing deforming amount of the sealing members at the cut/off position and the communicative position. The above object of the invention is realized by an on-off valve including a substantially cylindrical bush having an air path, which communicates an outside of the bush with an inside of the bush, an on/off operator inserted at an outer periphery of the bush, having a substantially circular shape, and including a first groove having a substantially circular shape and formed on an inner periphery of the bush; and a second groove having a substantially circular shape and being apart from the first groove, a first elastic body disposed in the first groove, having a substantially annular shape, and being slidable along the outer periphery of the bush, and a second elastic body disposed in the second groove, having a substantially annular shape, and being slidable along the outer periphery of the bush,

in which the on/off operator switches between a cut-off position where the air path is located between the first elastic body and the second elastic body so as to insulate the air path from the atmosphere and a communication position where the air path is not located between the first elastic body and the second elastic body so as to communicate the air path with the atmosphere, at least a part of a portion of the outer periphery of the bush, which is opposed to at lease one of the first elastic body and the second elastic body when the on/off operator moves between the cut-off position and the communicative position, is larger in an outer diameter than other part of the outer periphery of the bush.

According to a ninth aspect of the invention, an object of the invention is to seal more surely. The above object is realized by an on-off valve including a substantially cylindrical bush having an air path, which communicates an outside of the bush with an inside of the bush; an on/off operator inserted at an outer periphery of the bush, having a substantially circular shape, and including a first groove having a substantially circular shape and formed on an inner periphery of the bush and a second groove having a substantially circular shape and being apart from the first groove, a first elastic body disposed in the first groove, having a substantially annular shape, and being slidable along the outer periphery of the bush and a second elastic body disposed in the second groove, having a substantially annular shape, and being slidable along the outer periphery of the bush, in which the on/off operator switches between a cut-off position where the air path is located between the first elastic body and the second elastic body so as to insulate the air path from the atmosphere and a communication position where the air path is not located between the first elastic body and the second elastic body so as to communicate the air path with the atmosphere and, an outer diameter of a part of an outer periphery of the bush, which is opposed to the first elastic body or the second elastic body when the on/off operator is at the cut-off position, is larger than that of an outer diameter of a part of an outer periphery of the bush, which is opposed to the first elastic body or the second elastic body when the on/off operator is the communicative position.

According to a tenth aspect of the invention, an object of the invention is to provide a nailer which can switch between the single shots mode and the repetition shots more surely. The above object is realized by a nailer including an accumulator accumulating a compressed air, a cylinder having a substantially cylindrical shape and being communicatable with the accumulator, and extending in an upper and lower direction, a piston provided in the cylinder and being slidable with the cylinder; a driver blade being continuation with the piston to extend in a lower direction of the piston, a cylinder valve that alternatively switches between communication of an inside of the cylinder valve with the accumulator and a communication of the cylinder valve with atmosphere, and includes a first path communicating the cylinder valve with the accumulator, a second path communicating the cylinder valve with the atmosphere; and an on/off valve provided in the middle of the second path and including a cylindrical bush through which a fluid is passed, a hole communicating an interior of the cylindrical bush with an atmosphere, an on/off operator sliding along an outer peripheral axial direction of the cylindrical bush to open and close the hole, and a stopper elastic body served to position the on/off operator, in which the cylinder valve operates to communicate the inside of the cylinder with the accumulator when the first path opens, the cylinder valve activates to communicate the inside of the cylinder with the atmosphere when the second path opens and the on-off valve switches between a communication of the inside of the bush with the second path and an insulation of the second path from the atmosphere.

### BRIEF DESCRIPTION OF THE DRAWINGS

FIG. 1 is a side sectional view of an embodiment of a nailer incorporating an on/off valve according to the present invention.

FIG. 2 is a side partial sectional view of an embodiment of the communicating position of an on/off valve of the present invention.

FIG. 3 is a side partial sectional view of an embodiment of the interrupting position of an on/off valve described of the present invention.

FIG. 4 is a side partial sectional view of an embodiment of the communicating position of an on/off valve of the present invention.

FIG. 5 is a side partial sectional view of an embodiment of the interrupting position of an on/off valve of the present invention.

FIG. 6 is a side partial sectional view of an embodiment of the communicating position of a conventional on/off valve communicating position according to a prior art.

FIG. 7 is a side partial sectional view of an embodiment of the interrupting position of a conventional on/off valve according to a prior art.

FIG. 8 is a side partial sectional view of an embodiment of the communicating position of a conventional on/off valve according to a prior art.

FIG. 9 is a side partial sectional view of an embodiment of the interrupting position of a conventional on/off valve according to a prior art.

FIG. 10 is a side partial sectional view of an embodiment of the communicating position of a conventional on/off valve according to a prior art.

FIG. 11 is a side partial sectional view of an embodiment of the interrupting position of a conventional on/off valve according to a prior art.

### DETAILED DESCRIPTION OF THE PREFERED EMBODIMENTS

As an embodiment of the present invention, an explanation will be given an on/off valve 1 for exchanging a nailer, which is operated using compressed air, between a single shot and repetition shots.

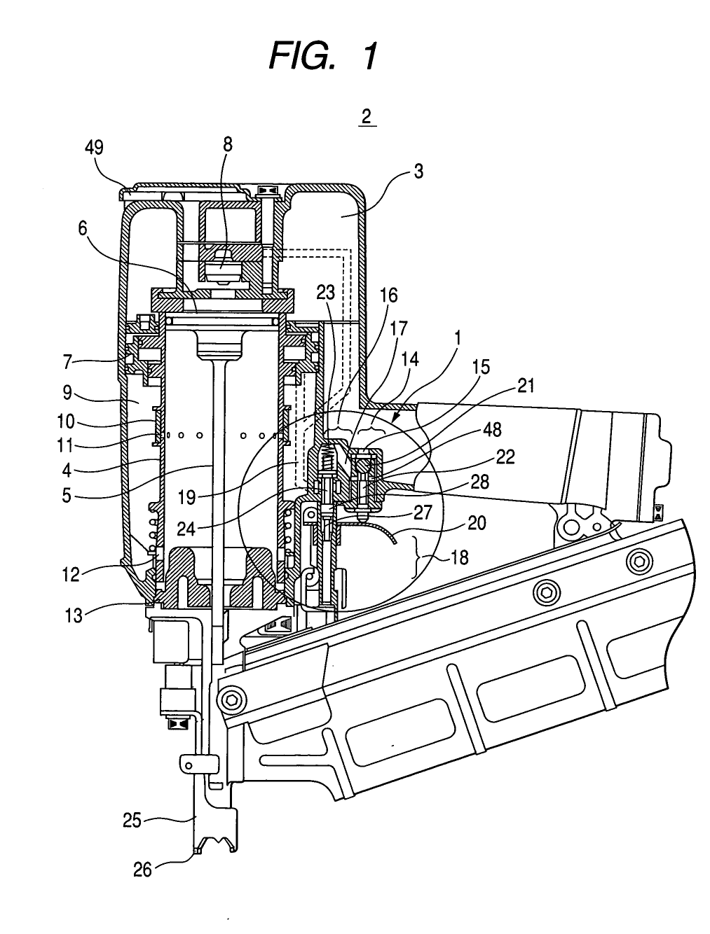

FIGS. 1 to 3 show an embodiment of an on/off valve 1 according to an aspect of the present invention.

In a nailer 2, compressed air fed from a compressor (not shown) is accumulated in an accumulator 3 through an air hose and an air plug (not shown). A body of the nailer 2 incorporates a cylindrical cylinder 4 which incorporates a piston 6 integrally equipped with a driver blade 5 for driving a nail to be slidable vertically. On the outer periphery of the upper part of the cylinder 4, a cylinder valve 7 is provided. When the cylinder 4 is lowered, the upper end of the cylinder 4 is opened and an exhausting valve 8 is closed, thereby communicating the accumulator 3 with the upper part of the piston 6 within the cylinder 4. On the other hand, when the cylinder valve 7 is raised, the upper end of the cylinder 4 is closed and exhausting valve 8 is opened, thereby communicating the upper part of the piston 6 within the cylinder 4 with the atmosphere. On the outer periphery of the cylinder 4, a return chamber 9 is provided to return the piston 6 to an upper dead point. On the way of the reciprocating stoke of the piston 6, an air path 11 equipped with a stopper valve 10 which opens from the cylinder 4 only toward the return chamber 9 is provided. On the outer periphery of the lower end of the cylinder 4, an air path 12 for communicating the cylinder 4 and the return chamber 9 to each other is provided. At the lower end of the cylinder 4, a piston bumper 13 for absorbing surplus energy of the piston 6 after having been nail-drived is provided.

The accumulator 3 communicates with a trigger valve 14 through an air path 15. The trigger valve 14 communicates with a trigger valve 16 through an air path 17. And, the cylinder valve 7, exhausting valve 8 and on/off valve 18 according to the present invention communicate with the trigger valve 16 through an air path 19.

The trigger valve 14 is provided with a ball 21 which is pressed toward a trigger 20 by the compressed air in the accumulator 3 and a plunger 22 which serves to push up the ball 21 through the pulling operation of the trigger 20 and interrupt a trigger valve air chamber 48 from the atmosphere.

The trigger valve 16 is provided with a plunger 24 which is pressed by a spring 23 in a direction of interrupting the air paths 17 and 19; an upper end 27 of a push lever 26 which is provided to protrude from an outlet 25 of the nailer 2 to be urged slidably in the axial direction and is pushed up when it is brought into contact with wood; and a valve bush 30 which forms a plunger air chamber 28 together with an on/off operator 29 of an on/off valve 18 for on/off controlling the communication between a trigger valve air chamber 48 and the atmosphere, thereby constituting the on/off valve 18. The outer periphery of the valve bush 30 are provided a groove 32 in which a stopper elastic body 31 for the on/off operator 29 is to be fit and an air path 33 for communicating the plunger air chamber 28 with the atmosphere. On the inner face of the on/off operator 29, O-rings 34 and 35 are provided to seal the on/off operator 29 and the outer periphery of the valve bush 30.

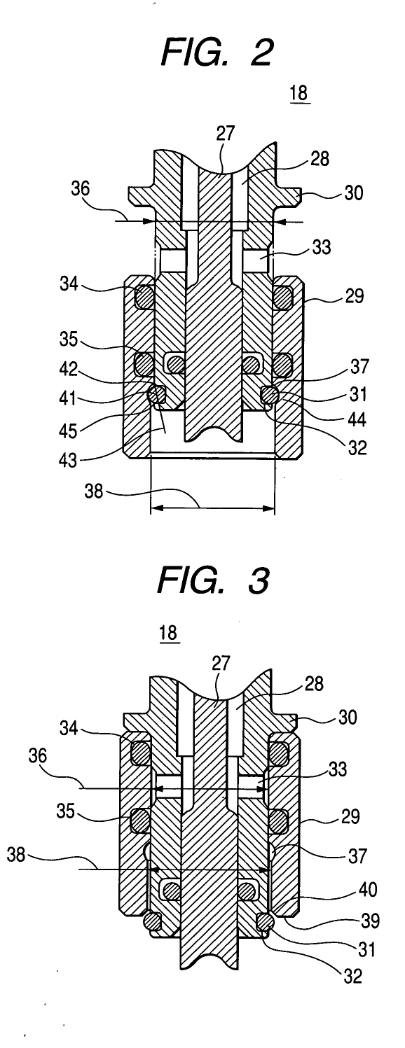

In an embodiment of the present invention shown in FIGS. 1 to 3, at the communicating position as shown in FIG. 2, both the O-rings 34 and 35 seal the outer periphery of the valve bush 30, but the air path 33 which is located on the upper side of the O-ring 34 communicates with the atmosphere. The on/off operator 29 is positioned in such a manner that the stopper elastic body 31 engages with a positioning groove 37 which is formed on the inner face of the on/off operator 29 so as to have a larger diameter than a sliding inner diameter B. The sliding inner diameter A is set be smaller than the sliding inner diameter B. Thus the inner diameter A defines a wall which restricts the movable distance of the on-off operator 29 by engaging with the stopper elastic body 31.

At the interrupting position, both the O-rings 34 and 35 seal the outer periphery of the valve bush 30. The air path 33, which is located between the O-rings 34 and 35, is interrupted from the atmosphere. An end face 39 of the on/off operator 29 is formed corresponding to the stopper elastic body 31. A chamfering portion 40 is formed by the sliding inner diameter B with the stopper elastic body 31 and the end face 39 of the on/off operator 29. The chamfering portion 40 engages with the stopper elastic body 31. Thus the on/off operator 29 is positioned at an intersecting point of the sliding surface B and the end face 39. Namely, the positioning groove for the interrupting position is not required.

In order that the on/off operator 29 is located at the communicating position, the on/off operator 29 is moved downward in the axial direction. At this time, the stopper elastic body 31 is deformed to the sliding inner diameter B.

As seen from FIG. 2, a groove 37 is formed inside the on/off operator 29. An intersecting point 42 is defined by the positioning groove 37 and the sliding inner diameter A 36. An intersecting point 45 is defined by the sidewall 44 of the groove 32 and the sliding inner diameter A 36. The extended line of the line coupling a central position 41 of the stopper elastic body 31 with the intersecting point 42 passes nearer to the axial center than the intersecting point 45. For this reason, even when the on/off operator 29 is abruptly moved downward, the stopper elastic body 31 is pressed inside of the groove 32, thus the stopper elastic body 31 does not come off from the groove 32.

An explanation will be given of the operation of the nailer incorporating the on/off operator. At the communicating position of the on/off valve 18, the nailer 2 is placed in a state of making repetition shots. In this configuration, the state of repetition shots is as follows. After the operation of pushing up a push lever 26 and the operation of pulling the trigger 20 are simultaneously realized and the piston 6 has been lowered, when the push lever 26 is returned with the trigger being pulled, the piston 6 returns to the upper dead point of an initial position. By repeating the operation of the push lever 26 with the trigger being pulled, nails can be drived repeatedly.

At the interrupting position of the on/off valve 18, the nailer 2 is placed in a state of making a single shot. In this configuration, the state of making the single shot is as follows.

After the operation of pushing up the push lever 26 and the operation of pulling the trigger 20 are simultaneously realized and the piston has been lowered, if the trigger 20 remains pulled, even when the push lever is returned, the piston remains lowered. Even when the push lever 26 is pushed up, the nail cannot be drived.

First, the operating process of the repetition shots will be explained. The on/off operator 29 is moved to the communicating position at the lower side in the axial direction. When the air hose is connected to the body of the nailer 2, the compressed air is accumulated in the accumulator 3. A part of the compressed air flows into the ball 21 through the air path 15. The cylinder 4 remains interrupted from the accumulator 3.

Next, when the trigger 20 is pulled, the plunger 22 pushes up the ball 21 so that the compressed air flows into the trigger valve air chamber 48 and the air path 17 and the trigger valve air chamber 48 is interrupted from the atmosphere.

Next, when the push lever 26 is pushed up, at the upper end 27, the plunger 24 is pushed up. As a result, the trigger valve air chamber 48 communicates with the trigger valve air chamber 28 so that the compressed air flows into the cylinder valve 7 and exhausting valve 8 through the air path 19. Thus, the exhausting valve 8 closes to interrupt the upper side of the piston 6 of the cylinder 4 from the atmosphere. Then, the cylinder valve 7 opens abruptly so that the upper side of the piston of the cylinder 4 communicates with the accumulator 3. As a result, the compressed air in the accumulator 3 flows into the cylinder 4 to push the piston down, thereby driving the nail into wood by the tip of the driver blade 5. By the surplus energy after driving, the piston bumper 13 is deformed.

The air on the lower side of the piston 6 within the cylinder 4 is compressed gradually and flows into the return chamber 9 through the air path 12. When the piston 6 descends to pass the air path 11, a part of the compressed air on the upper side of the piston 6 within the cylinder 4 flows into the return chamber 9.

Next, when the push lever 26 is returned, the plunger 24 returns owing to the pushing force of the spring 23. As a result, the trigger valve air chamber 28 is interrupted from the accumulator 3. The trigger valve air chamber 28 communicates with the atmosphere through the air path 33. The compressed air in the cylinder valve 7 and exhausting valve 8 is exhausted through the air path 19. Thus, the exhausting valve 8 opens so that the upper side of the piston 6 in the cylinder 4 communicates with the atmosphere. As a result, the compressed air on the upper side of the piston 6 within the cylinder 4 is exhausted from the exhausting outlet 49 so that the piston 6 returns to the upper dead point owing to the compressed air flowed into the return chamber 9. With the trigger 20 being pulled, when the push lever 26 is pushed up again, the driving operation is performed again.

In order to change the operation of the single shot, the on/off operator 29 is moved upward in the axial direction.

In the case of the configuration described above, at both communicating position and interrupting position, the sliding inner diameter A at the sealing portion between the O-rings 34, 35 and the valve bush 30 is unvaried on the entire face. Thus, the deforming quantity of the O-rings 34 and 35 is unvaried so that poor sealing does not result.

The positioning of the on/off operator 29 will be performed as follows. When the on/off operator 29 is moved upward in the axial direction, the stopper elastic body 31 having engaged with the positioning groove 37 is deformed to the sliding inner diameter B to climb over the positioning groove 37. By moving the on/off operator 29 further, the stopper elastic body 31 climbs over the portion of the sliding inner diameter B. Thus, the on/off operator 29 is positioned at the chamfering portion 40 defined by the sliding inner diameter B and the end face 39 of the on/off operator 29.

Next, the operating stroke of the single shot will be explained. Like the operation of the repetition shots, after the air hose is has been connected, when the push lever 26 is pushed up, the plunger 24 is also pushed up. As a result, the trigger valve air chamber 48 communicates with the trigger valve air chamber 28 so that the cylinder valve 7 communicates with the exhausting valve 8 through the air path 19. The trigger valve 14 remains interrupted from the accumulator 3 at the atmospheric pressure so that the cylinder valve 7 and the exhausting valve 8 are not operated.

When the trigger 20 is pulled, the plunger 22 pushes up the ball 21 so that the compressed air in the accumulator 3 flows into the trigger valve air chamber 48 and the trigger valve air chamber 48 is interrupted from the atmosphere. The exhausting valve 8 closes to interrupt the upper side of the piston 6 of the cylinder 4 from the atmosphere. Then, the cylinder valve 7 opens abruptly so that the upper side of the piston of the cylinder 4 communicates with the accumulator 3. As a result, the compressed air in the accumulator 3 flows into the cylinder 4 to push the piston down, thereby driving the nail into wood by the tip of the driver blade 5. Like the operation of the repetition shots, by the surplus energy after driving, the piston bumper 13 is deformed. The air on the lower side of the piston 6 within the cylinder 4 is compressed gradually and flows into the return chamber 9 through the air path 12. When the piston 6 descends to pass the air path 11, a part of the compressed air on the upper side of the piston 6 within the cylinder 4 flows into the return chamber 9.

With the trigger 20 having been pulled, when the push lever 26 is returned, the plunger 24 returns owing to the pushing force of the spring 23 to interrupt the trigger valve air chamber 28 from the accumulator 3. However, since the air path 33 has been interrupted from the atmosphere and the trigger valve air chamber 28 by the on/off valve 18, and the compressed air in the sylinder valve 7 and the exhausting valve 8 is not exhausted, thus the piston 6 remains at the lower dead point. When the trigger 20 is returned, the trigger air chamber 48 is interrupted from the accumulator 3 owing to the ball 21. The trigger valve air chamber 48 communicates with the atmosphere to exhaust the compressed air from the cylinder valve 7 and exhausting valve 8. Thus, the exhausting valve 8 opens to communicate the upper side of the piston 6 in the cylinder 4 with the atmosphere. The compressed air on the upper side of the piston 6 in the cylinder 4 is exhausted from the exhausting outlet 49. Owing to the compressed air flowed into the return chamber 9, the piston 6 returns to the upper dead point.

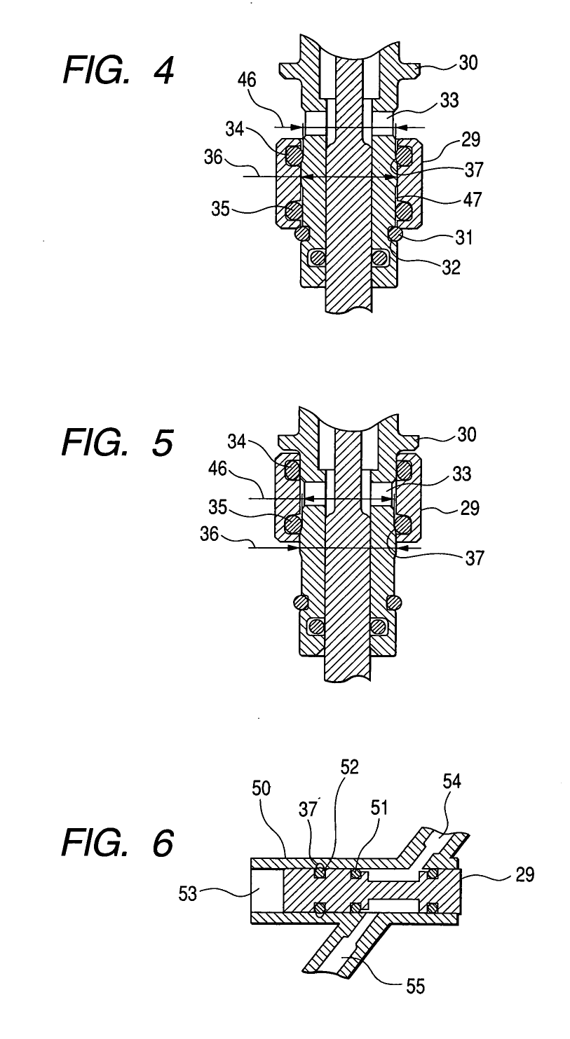

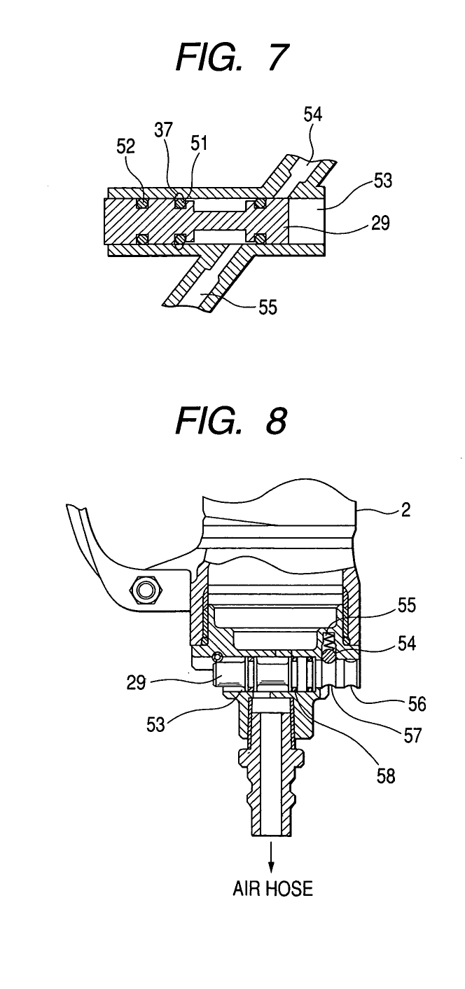

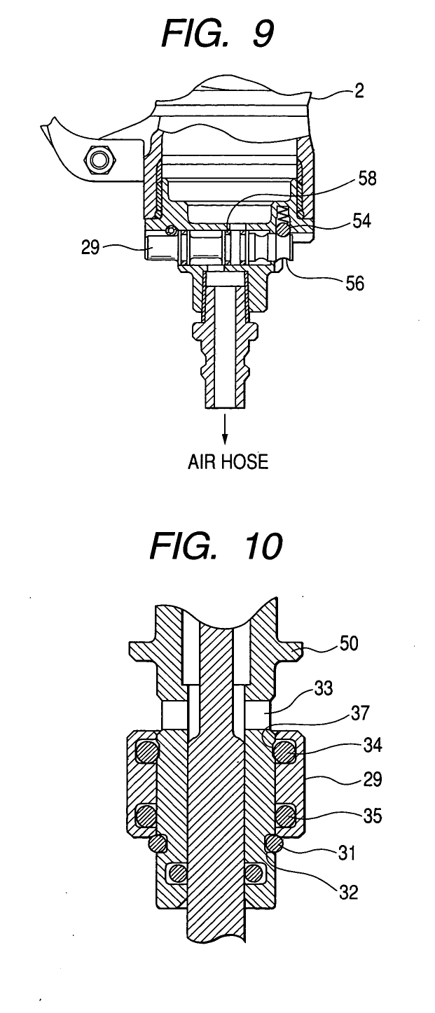

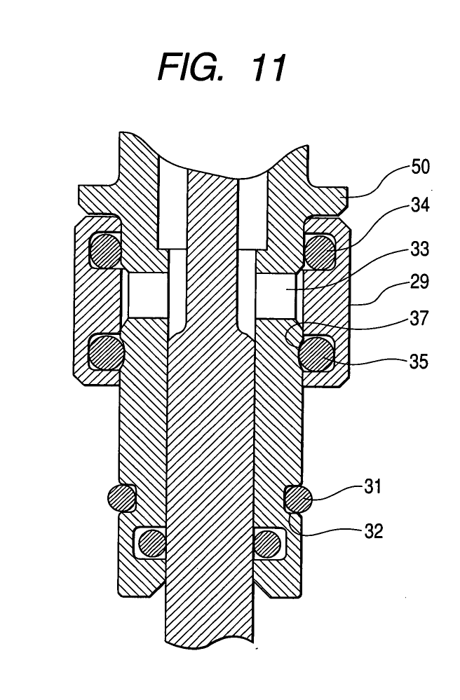

Referring to FIGS. 4 and 5, an explanation will be given of another embodiment of the on/off valve according to the present invention.

At the communicating position as shown in FIG. 4, an O-ring 34 is sealed to the outer periphery of the valve bush 30 and engages with the positioning groove 37, thereby positioning the on/off operator 29. The O-ring 35 is located at a refuging position 47 to provide a diameter equal to or smaller than the diameter B 46 at the positioning groove. The air path 33, which is located on the upper side of the O-ring 34, communicates with the atmosphere. In order to prevent the on/off operator 29 from coming off downward, the stopper elastic body 31 is fit in the groove 32 on the outer periphery of the valve bush 30.

At the interrupting position as shown in FIG. 5, both the O-rings 34 and 35 seal the outer periphery of the valve bush 30. The air path 33, which is located between the O-rings 34 and 35, is interrupted from the atmosphere. The on/off operator 29 is positioned in such a manner that the O-ring 35 engages with the positioning groove 37 formed on the outer periphery of the valve bush 30. The O-ring 35 is employed for both sealing and positioning the on/off operator 29. The positioning grove 37 has a diameter smaller than the sliding inner diameter A 36.

In order that the on/off operator 29 is located at the communicating position, it is moved downward in the axial direction. In this case, the O-ring 35 is deformed to the sliding inner diameter A 36.

In the configuration described above, since the outer diameter of the refuging position 47 is equal to or smaller than that at the groove 37, when the on/off operator 29 is moved from the communicating position to the interrupting position, the deforming quantity of the O-ring 34 increases and that of the O-ring 35 remains unvaried or increases. Thus, poor sealing does not result.

The positioning of the on/off operator 29 will be performed as follows. When the on/off operator 29 is moved upward in the axial direction, the o-ring 34 having engaged with the positioning groove 37 is deformed to the sliding inner diameter A to climb over the positioning groove 37. By moving the on/off operator 29 further, the O-ring 35 climbs from the refuging position 47 over the portion of the sliding inner diameter A and is sealed to the positioning groove 37. Thus, the on/off operator 29 is positioned.

In accordance with the present invention, the invention adopts the structure in which the O-ring is dedicated for sealing and the stopper elastic body is served to position the on/off operator, thereby preventing the O-ring from remaining deformed, thereby surely following a groove shape to be sealed.

The invention adopts the structure in which the stopper elastic body is fit over the outer periphery of the cylindrical bush; and the on-off operator has an positioning groove providing an outer diameter not smaller than the stopper elastic body does, a sliding face sliding in the axial direction with the stopper elastic body and a wall permitting the on/off operator to slide over only a prescribed distance; the positioning groove, the sliding face and the wall provide a larger diameter in this order, thereby preventing the elastic body from remaining deformed, thereby surely following a groove shape to be sealed.

The invention adopts the extended line of the line coupling a central position of the stopper elastic body with an intersecting point of the wall and sliding inner diameter between said on/off operator and said cylindrical bush passes nearer to the axial center of said bush than an intersecting point of the side wall of the groove formed on the outer periphery of said bush and said outer periphery so that when the on/off operator is operated in the axial direction, the stopper elastic body does not come off from the groove.

The invention adopts the structure in which the on/off operator is positioned at an intersecting point of the sliding face and end face of the on/off operator so that the structure is simplified to realize low cost, small size and light weight.

The invention adopts the structure in which the sealing member served for sealing and positioning by engagement with the positioning groove at an interrupting position of the on/off operator gives a smaller interference at a communicating position of the on/off operator than at the interrupting position. Therefore, in the system in which the elastic body is served to position the on/off operator and to interrupt the air path from the atmosphere, the elastic body can be surely sealed.

The invention adopts the structure in which an on-off valve, in which when the on/off operator moves between the cut-off position and the communicative position, an inner diameter of the on/off operator is smaller than that of the positioning groove on one side facing the third elastic body as viewed from the positioning groove, and when the on/off operator moves between the cut-off position and the communicative position, the inner diameter of the on/off operator is larger than an outer diameter of the bush at the other side as viewed from the positioning groove. In this way, since the first elastic body and the second elastic body is served as a sealing member and the third elastic body engages with the forth groove to serve as a positioning member, it can be achieved to prevent the seal members from remaining deformed.

The invention adopts the structure in which an on-off valve, in which when the on/off operator moves between the cut-off position and the communicative position, an inner diameter of the on/off operator is smaller than that of the positioning groove on one side facing the third elastic body as viewed from the positioning groove, and when the on/off operator moves between the cut-off position and the communicative position, the inner diameter of the on/off operator is larger than an outer diameter of the bush at the other side as viewed from the positioning groove. In this way, when the on/off operator moves to the cut-off position or the communicative position, it is easy to deform the third elastic body 31, thus the on/off operator can move easily. However, when the on/off operator changes to the direction of neither the cut-off position or the communicative position, it is hard to deform the third elastic body, thus the third elastic body of the sealing member offer a retaining effect.

The invention adopts the structure in which an on-off valve including a substantially cylindrical bush having an air path, which communicates an outside of the bush with an inside of the bush, an on/off operator inserted at an outer periphery of the bush, having a substantially circular shape, and including a first groove having a substantially circular shape and formed on an inner periphery of the bush; and a second groove having a substantially circular shape and being apart from the first groove, a first elastic body disposed in the first groove, having a substantially annular shape, and being slidable along the outer periphery of the bush, and a second elastic body disposed in the second groove, having a substantially annular shape, and being slidable along the outer periphery of the bush, in which the on/off operator switches between a cut-off position where the air path is located between the first elastic body and the second elastic body so as to insulate the air path from the atmosphere and a communication position where the air path is not located between the first elastic body and the second elastic body so as to communicate the air path with the atmosphere, at least a part of a portion of the outer periphery of the bush, which is opposed to at lease one of the first elastic body and the second elastic body when the on/off operator moves between the cut-off position and the communicative position, is larger in an outer diameter than other part of the outer periphery of the bush. In this way, when the on/off operator moves between the cut-off position and the communicative position, since the first elastic body or the second elastic body is compressed and become to resist, the first elastic body or the second elastic body is served as a positioning member. Also, it is not necessary to change a deforming amount of the first elastic body and the second elastic body.

The invention adopts the structure in which an on-off valve including a substantially cylindrical bush having an air path, which communicates an outside of the bush with an inside of the bush; an on/off operator inserted at an outer periphery of the bush, having a substantially circular shape, and including a first groove having a substantially circular shape and formed on an inner periphery of the bush and a second groove having a substantially circular shape and being apart from the first groove; a first elastic body disposed in the first groove, having a substantially annular shape, and being slidable along the outer periphery of the bush and a second elastic body disposed in the second groove, having a substantially annular shape, and being slidable along the outer periphery of the bush, in which the on/off operator switches between a cut-off position where the air path is located between the first elastic body and the second elastic body so as to insulate the air path from the atmosphere and a communication position where the air path is not located between the first elastic body and the second elastic body so as to communicate the air path with the atmosphere and, an outer diameter of a part of an outer periphery of the bush, which is opposed to the first elastic body or the second elastic body when the on/off operator is at the cut-off position, is larger than that of an outer diameter of a part of an outer periphery of the bush, which is opposed to the first elastic body or the second elastic body when the on/off operator is the communicative position. In this way, when the on/off operator is at the cut/off position, deforming amount of the first elastic body or the second elastic body became larger compared with the case where the on/off operator is at the cut/off position, thus sealing can be achieved more surely.

The invention adopts the structure in which a nailer which can switch between the single shots mode and the repetition shots more surely. The above object is realized by a nailer including an accumulator accumulating a compressed air, a cylinder having a substantially cylindrical shape and being communicatable with the accumulator, and extending in an upper and lower direction, a piston provided in the cylinder and being slidable with the cylinder; a driver blade being continuation with the piston to extend in a lower direction of the piston, a cylinder valve that alternatively switches between communication of an inside of the cylinder valve with the accumulator and a communication of the cylinder valve with atmosphere, and includes a first path communicating the cylinder valve with the accumulator, a second path communicating the cylinder valve with the atomosphere; and an on/off valve provided in the middle of the second path and including a cylindrical bush through which a fluid is passed, a hole communicating an interior of the cylindrical bush with an atmosphere, an on/off operator sliding along an outer peripheral axial direction of the cylindrical bush to open and close the hole, and a stopper elastic body served to position the on/off operator, in which the cylinder valve operates to communicate the inside of the cylinder with the accumulator when the first path opens, the cylinder valve activates to communicate the inside of the cylinder with the atomosphere when the second path opens and the on-off valve switches between a communication of the inside of the bush with the second path and an insulation of the second path from the atmosphere.

The invention adopts the structure of an on-off valve, in which, when the on/off operator moves between the cut-off position and the communicative position, an inner diameter of the on/off operator is smaller than that of the positioning groove on one side facing the third elastic body as viewed from the positioning groove, and when the on/off operator moves between the cut-off position and the communicative position, the inner diameter of the on/off operator is larger than an outer diameter of the bush at the other side as viewed from the positioning groove. In this way, since the first elastic body and the second elastic body is served as a sealing member and the third elastic body engages with the forth groove to serve as a positioning member, it can be achieved to prevent the seal members from remaining deformed. In this way, when the second path is interrupted from the air, the piston become not to be upped, thus the single shots mode is achieved. When the second path communicates with the atmosphere, the repetition mode is achieved. By adopting the above on-off valve, it can be achieved to provide a nailer which can switch between the single shots mode and the repetition shots more surely.

What is claimed is:

1. An on-off valve comprising:
a cylindrical bush through which a fluid is passed;
a hole communicating an interior of the cylindrical bush with an atmosphere;
an on/off operator sliding along an outer peripheral axial direction of the cylindrical bush to open and close the hole; and
a stopper elastic body served to position the on/off operator.

2. The on/off valve according to claim 1, further comprising:
a sliding face sliding in an axial direction of the axial direction of the cylindrical bush; and
a wall permitting the on/off operator to slide over a predetermined distance,
wherein the stopper elastic body is fit over a outer periphery of the cylindrical bush,
the on-off operator has an positioning groove providing an outer diameter which is more than the stopper elastic body does, and
a diameter of the positioning groove is more than that of the sliding face, and a diameter of the wall is smaller than that of the sliding face.

3. The on/off valve according to claim 2,
Wherein a groove having a substantially circular shape is formed on the outer periphery of the cylindrical bush, the stopper elastic body is disposed in the groove formed on the outer periphery of the cylindrical bush,
an extended line of line coupling a central position of a cross-section of the stopper elastic body with an intersecting point of the groove and an inner periphery of the wall passes nearer to an axial center than an intersection of a side wall of the groove and the inner periphery of the wall.

4. The on/off valve according to claim 1, wherein the on/off operator is positioned at an end face of the on/off operator.

5. An on-off valve comprising:
a cylindrical bush through which a fluid is passed;
a hole communicating an interior of the cylindrical bush with an atmosphere;
an on/off operator sliding along an outer peripheral axial direction of the cylindrical bush to open and close the hole;
at least one of sealing members mounted inside the on/off operator; and
a positioning groove that positions the on/off operator formed on an outer periphery of the bush with which the sealing members are engaged,
wherein the sealing members are located at upper and lower positions in an axial direction of the hole when the interior of the bush is interrupted from the atmosphere,
the sealing members are located at the one side with respect to the hole in the axial direction of the hall when the interior of the bush is communicated with the atmosphere, and
the sealing member which seals and positions by engagement with the positioning groove at an interrupting position of the on/off operator gives a smaller interference at a communicating position of the on/off operator than at the interrupting position of the on/off operator.

6. An on-off valve comprising:
a substantially cylindrical bush having an air path, which communicates an outside of the bush with an inside of the bush;
an on/off operator inserted at an outer periphery of the bush, having a substantially circular shape, and including:
a first groove having a substantially circular shape and formed on an inner periphery of the bush; and
a second groove having a substantially circular shape and being apart from the first groove;
a first elastic body disposed in the first groove, having a substantially annular shape, and being slidable along the outer periphery of the bush;
a second elastic body disposed in the second groove, having a substantially annular shape, and being slidable along the outer periphery of the bush; and
a third elastic body disposed in a third groove, which has a substantially circular shape and is formed on the outer periphery of the bush, and protruding from the outer periphery of the bush,
wherein the on/off operator switches between a cut-off position where the air path is located between the first elastic body and the second elastic body so as to insulate an atmosphere from the air path and a communication position where the air path is not located between the first elastic body and the second elastic body so as to communicate the air path with the atmosphere; and
a positioning groove has a substantially circular shape, is formed on an inner periphery of the bush, and is opposed to the third elastic body when the on/off operator is at the cut-off position or the communicative position.

7. The on-off valve according to claim 6,
wherein when the on/off operator moves between the cut-off position and the communicative position, an inner diameter of the on/off operator is smaller than that of the positioning groove on one side facing the third elastic body as viewed from the positioning groove; and
when the on/off operator moves between the cut-off position and the communicative position, the inner diameter of the on/off operator is larger than an outer diameter of the bush at the other side as viewed from the positioning groove.

8. An on-off valve comprising:
a substantially cylindrical bush having an air path, which communicates an outside of the bush with an inside of the bush;
an on/off operator inserted at an outer periphery of the bush, having a substantially circular shape, and including:
a first groove having a substantially circular shape and formed on an inner periphery of the bush; and
a second groove having a substantially circular shape and being apart from the first groove;
a first elastic body disposed in the first groove, having a substantially annular shape, and being slidable along the outer periphery of the bush; and
a second elastic body disposed in the second groove, having a substantially annular shape, and being slidable along the outer periphery of the bush,
wherein the on/off operator switches between a cut-off position where the air path is located between the first elastic body and the second elastic body so as to insulate the air path from the atmosphere and a communication position where the air path is not located between the first elastic body and the second elastic body so as to communicate the air path with the atmosphere,
at least a part of a portion of the outer periphery of the bush, which is opposed to at lease one of the first elastic body and the second elastic body when the on/off operator moves between the cut-off position and the communicative position, is larger in an outer diameter than other part of the outer periphery of the bush.

9. An on-off valve comprising:
a substantially cylindrical bush having an air path, which communicates an outside of the bush with an inside of the bush;
an on/off operator inserted at an outer periphery of the bush, having a substantially circular shape, and including:
a first groove having a substantially circular shape and formed on an inner periphery of the bush; and
a second groove having a substantially circular shape and being apart from the first groove;
a first elastic body disposed in the first groove, having a substantially annular shape, and being slidable along the outer periphery of the bush; and
a second elastic body disposed in the second groove, having a substantially annular shape, and being slidable along the outer periphery of the bush,
wherein the on/off operator switches between a cut-off position where the air path is located between the first elastic body and the second elastic body so as to insulate the air path from the atmosphere and a communication position where the air path is not located between the first elastic body and the second elastic body so as to communicate the air path with the atmosphere; and,
an outer diameter of a part of an outer periphery of the bush, which is opposed to the first elastic body or the second elastic body when the on/off operator is at the cut-off position, is larger than that of an outer diameter of a part of an outer periphery of the bush, which is opposed to the first elastic body or the second elastic body when the on/off operator is the communicative position.

10. A nailer comprising:
an accumulator accumulating a compressed air;
a cylinder having a substantially cylindrical shape and being communicatable with the accumulator, and extending in an upper and lower direction;
a piston provided in the cylinder and being slidable with the cylinder;
a driver blade being continuation with the piston to extend in a lower direction of the piston;
a cylinder valve that alternatively switches between communication of an inside of the cylinder valve with the accumulator and a communication of the cylinder valve with anatmosphere, and includes:
a first path communicating the cylinder valve with the accumulator;
a second path communicating the cylinder valve with the atomosphere; and
an on/off valve provided in the middle of the second path and including:
a cylindrical bush through which a fluid is passed;
a hole communicating an interior of the cylindrical bush with an atmosphere;
an on/off operator sliding along an outer peripheral axial direction of the cylindrical bush to open and close the hole; and
a stopper elastic body served to position the on/off operator,
wherein the cylinder valve operates to communicate the inside of the cylinder with the accumulator when the first path opens;
the cylinder valve activates to communicate the inside of the cylinder with the atomosphere when the second path opens; and
the on-off valve switches between a communication of the inside of the bush with the second path and an insulation of the second path from the atmosphere.
